(19) United States
(12) Patent Application Publication
(10) Pub. No.: US 2009/0213480 A1
(43) Pub. Date: Aug. 27, 2009

(54) VEHICLE REAR MIROR HAVING A DISPLAY

(76) Inventor: Shin-Nan LI, Taipei (TW)

Correspondence Address: Shin-Nan LI, Box 8-24, 235 Chung - Ho, Taipei, 235, TW

(21) Appl. No.: 12/037,950

(22) Filed: Feb. 27, 2008

(51) Int. Cl. B60R 1/04

(52) U.S. Cl. 359/844; 359/838

(57) ABSTRACT

A vehicle rear mirror having a display comprises a seat having an insertion rod which is controlled by an electromagnetic valve; a body having a display unit; the body being slideable along the seat; the body being capable of moving outwards by an elastic force; one side of the body corresponding to the insertion rod of the seat having an insertion hole; when the body is in front of the seat; the insertion hole can receive the insertion rod so as to fix the body; when the insertion rod is released from the insertion hole, the body can be pushed outwards by elastic force; and a mirror with a mirror surface, the mirror being installed at a front side of the seat; when the body slides inwards, the body being hidden between the mirror and the seat; and when the body slides outwards, the body exposes out.

### FIELD OF THE INVENTION

The present invention relates to rear mirrors of vehicles, and particularly to a vehicle rear mirror having a display.

### BACKGROUND OF THE INVENTION

In the prior art, the display unit has been installed to a rear mirror of a car for improving the receiving function in data receiving and satellite navigation. With the improvement in technology, the function of display has been improved gradually, such as the video display, applications of multi-media, etc. However because the frame of the display must pass through a mirror surface, the color is easy to dirt or unclear due to the change of colors or the bad transmission effect of the mirror surfaces so as to affect the clearness of the images. In one prior art, a liquid crystal display is foldably and rotatably installed to a rear side of a rear mirror. In use, the display can protrude out manually for viewing. In another prior art, a retraction device is installed to the rear mirror for fixing a display so that the display can be hidden within the rear mirror of a car. In use, the retraction device will push the display outwards.

However in above former example, the display is operated manually, it is inconvenient. In the later example, the steadiness of the whole structure is not good and the sliding and positioning structure is not ideal so that the displacement of the display is not smooth. Furthermore, it is easy to be affected by the vibration of the car so as to affect the image and viewing qualities and lifetime of the product. Thus, in U.S. Pat. No. 7,175,291, assigned to the inventor of the present invention, a track and a slide guide unit are used to guide the sliding movement and a rack and an oil pressure gear are engaged to provide proper damping in operation so as to improve the steadiness and smooth of the displacement. Furthermore, tenons and buckles are used in lock. With the elastic force of the compressible spring, in operation, it is only necessary to eject upwards slightly, the tenon and buckle can be disengaged easily. Furthermore, elastic force serves to descend the display so as to improve the defects in the prior arts.

The U.S. patent still has some defects necessary to be improved. For example the structures of the tenon and the buckle are complicated and the costs in assembly and manufacturing are high. The display cannot be expanded, it is operated manually.

### SUMMARY OF THE INVENTION

Accordingly, the object of the present invention is to provide a vehicle rear mirror having a display, which has a simple locking structure. The operation is easy and the cost in assembly is low. Furthermore, the protruding and retraction of the device can be controlled remotely or by touch control so as to substitute the prior art manual operation.

To achieve above object, the present invention provides a vehicle rear mirror having a display, comprising: a seat having an insertion rod which is controlled by an electromagnetic valve; a body having a display unit; the body being slideable along the seat; the body being capable of moving outwards by an elastic force; one side of the body corresponding to the insertion rod of the seat having an insertion hole; when the body is in front of the seat; the insertion hole can receive the insertion rod so as to fix the body; when the insertion rod is released from the insertion hole, the body can be pushed outwards by elastic force; a mirror with a mirror surface, the mirror being installed at a front side of the seat; when the body slides inwards, the body being hidden between the mirror and the seat; and when the body slides outwards, the body exposes out from an outer edge of the mirror;

A slide guide device is installed between a front wall of the seat and a rear wall of the body. The slide guide device includes a guide rod and a track which are installed at two sides of the seat; and sliding block and a track slot are installed at two sides of the body; the slide block has a through hole for receiving the guide rod so that the sliding block is movable along the guide rod; the track of the seat is embedded into the track groove for guiding the seat.

An elastic device is installed between the seat and a rear wall of the body. The elastic device includes at least one compressible spring, a top positioning portion at a front wall of the seat; and a lower positioning portion on the rear wall of the body; an upper and a lower end of the compressible spring resist against the top positioning portion and the lower positioning portion, respective, so as to push the body downwards and outwards.

The top positioning portion of the seat is formed with a spring limiting groove.

The lower positioning portion of the body is formed with a spring limiting groove.

One lateral wall of the seat corresponding to the lateral wall of the body is provided with an engagement device for providing damping effect as the body slides. The engagement device has an oil pressure gear installed at one side of the front wall of the seat and a rack which is engaged to the oil pressure gear.

The wireless receiver is controlled by a wireless remote controller. The wireless remote controller is an infrared controller.

The wireless remote controller is used with a wireless receiver which is installed at a font lower side of the body.

The electromagnetic valve is a touch control switch. The touch control switch is installed at a front lower side of the body.

The electromagnetic valve is controlled by a far end wired control. The far end wire control includes a main frame having a touch control switch or with a wireless remote control function and a wire connected between the main frame and the electromagnetic valve so as to control the electromagnetic valve through the mainframe.

The mirror further includes a digital camera lens. The digital camera lens is installed at a front upper side of the mirror.

The present invention not only precisely provides the functions of limitation, steady sliding and buffering so as to avoid the effect of buckling and stopping, shocking, and vibration which will affect the image and viewing qualities and reduce the lifetime of the device. More important, the locking and releasing of the insertion rod from the insertion hole are controlled through an electromagnetic valve which is controlled wirelessly, wired and can be performed by touch control in far end. The operation is easy and conveniently with less force. Besides, the display unit can be installed to the mirror 40 so as to provide rear time images so as to have the effects of image storage and burglar proof. Furthermore, it provides a further value to the device of the present invention.

The various objects and advantages of the present invention will be more readily understood from the following detailed description when read in conjunction with the appended drawing.

### BRIEF DESCRIPTION OF THE DRAWINGS

FIG. 1 is an exploded perspective view of the vehicle rear mirror having a display of the present invention.

FIG. 2 is a backside view of the present invention.

FIG. 3 is a schematic view showing that the body protruding downwards.

FIG. 4 is a schematic view showing the initial state of the situation in FIG. 3.

FIG. 5 is a schematic view showing a lock state of the body of the present invention.

FIG. 6 is a schematic view showing a protruding state of the body of the present invention.

FIG. 7 is a schematic view showing a storage state of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

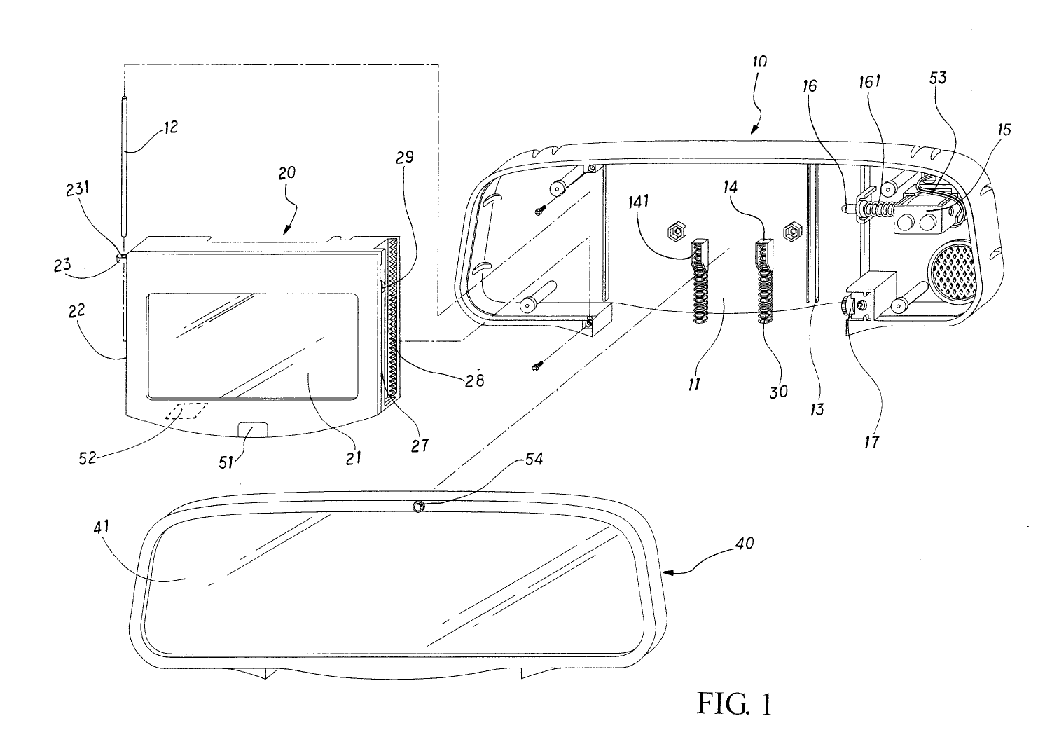

Referring to FIG. 1, the rear mirror of a vehicle with a display according to the present invention is illustrated. The present invention comprises a seat 10, a body 20, two compressible springs 30 and a mirror 40.

The seat 10 can be installed to a rear mirror (not shown) of a car. A front wall 11 of the seat 10 has a vertical guide rod 12 at a left side thereof. A right side of the front wall 11 has a track 13. Two top positioning portions 14 are installed between the guide rod 12 and the track 13. In this embodiment, each top positioning portion 14 is formed with a spring limiting groove 141. An insertion rod 16 is at a right upper side of the track 13 and on the front wall 11. The insertion rod 16 can reduce inwards by using an electromagnetic valve 15 and push outwards by using a restorable spring 161. An oil pressure gear 17 is at a lower side of the insertion rod 16.

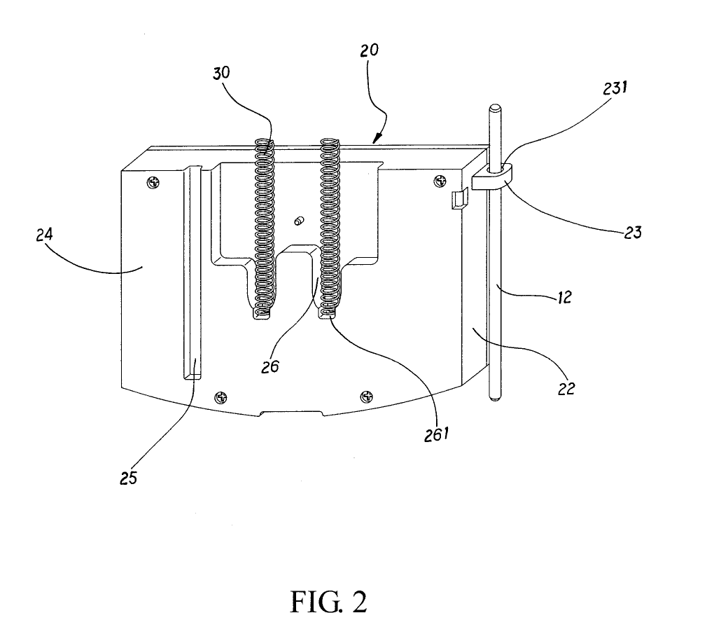

Referring to FIG. 2, the body 20 is installed with a display unit 21 which can be viewed from a front side thereof. A sliding block 23 protrudes from a left lateral wall 22. The sliding block 23 has a through hole 231. The guide rod 12 can pass through the through hole 231 so that the sliding block 23 can be guided along and limited by the guide rod 12. A rear wall 24 of the body 20 has a track groove 25 at a position corresponding to the track 13 of the seat 10. The track groove 25 can receive the track 13 for guiding the track 13. The track groove 25, track 13, the sliding block 23 and the guide rod 12 are formed as a guiding device. Two recessed lower positioning portions 26 are formed at the rear wall 25 of the body 20 at a position corresponding to the top positioning portions 14. In this embodiment, each lower positioning portion 14 is formed with a spring limiting groove 261. A right lateral wall 27 of the body 20 is installed with a rack 28 which can be engaged with the oil pressure gear 17 of the seat 10 so as to form as an engagement device. The engagement device also provides a damping effect as the body 20 moves along the seat 10. Further, an insertion hole 29 is formed at an upper side of the right lateral wall 27 of the body 20 for receiving the insertion rod 16 at a transversal direction. When the insertion rod 16 leaves from the insertion hole 29, the body 20 can be released.

Referring to FIG. 2, each of an upper and a lower end of the compressible spring 30 resists against the spring limiting groove 141 of the top positioning portion 14 and the lower positioning portion 26 of the body 20 so as to form as an elastic device. When the body 20 is at a front side, the compressible spring 30 can be compressible and thus store energy. When the insertion rod 16 of the seat 10 is acted by the electromagnetic valve 15 to separate from the insertion hole 29 of the body 20, the energy in the compressible spring 30 will be released as a form of elastic resilient force so as to push the body 20 to move downwards.

The mirror 40 is installed in front of the seat 10 and has a mirror surface 41. A space can be defined between the mirror 40 and the seat 10 for receiving the body 20. When the body 20 is fixed by the insertion rod 16 in the seat 10. The body 20 will receive and hid between the mirror 40 and the seat 10. Moreover, if the body 20 is released and is interacted by the resilient force of the compressible springs 30 so as to slide downwards. It will protrude from the lower side of the mirror 40. Therefore, the display unit 21 can be viewed by the operator.

It should be noted that referring to FIG. 1, the electromagnetic valve 15 in the seat 10 has various operation ways. In one way, it is controlled wirelessly, such as infrared ray remote control. In this embodiment, a front lower side of the body 20 is installed with a wireless receiver 51 which is used with a wireless remote control (not shown). Therefore, by the wireless receiver 51 to receive infrared ray signals, the turning on and off of the electromagnetic valve 15 is controlled so as to achieve the function of locking and releasing. In another way, a touch control way is used. In this embodiment, a front lower side of the body 20 is installed with a touch control switch 52. In operation, it is only necessary to touch the touch control switch 52 for controlling the electromagnetic valve 15.

In a further way, the far end wired control is used. In this embodiment, a main frame (not shown) with a touch control switch or with wireless remote control function is installed within a car. The main frame is connected to the electromagnetic valve 15 through a wire 53. Therefore, the electromagnetic valve 15 can be controlled through the wire 53.

Moreover, the present invention can provide other added function in the mirror 40, especially a front upper side of the mirror 40 is added with a digital camera lens 54 for capturing images in driving or stopping. The capturing images can be stored or transmit through satellites so as to have the function of capturing images and burglar proof.

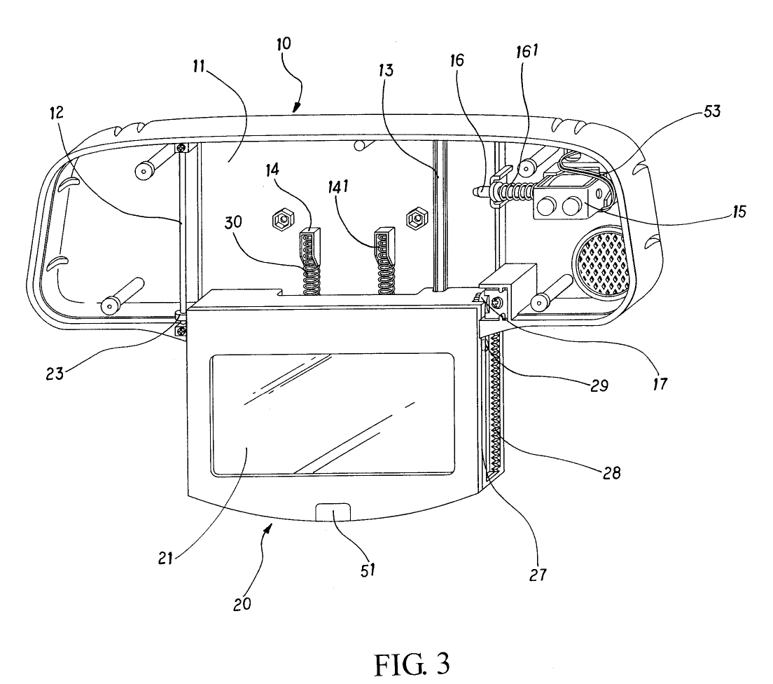

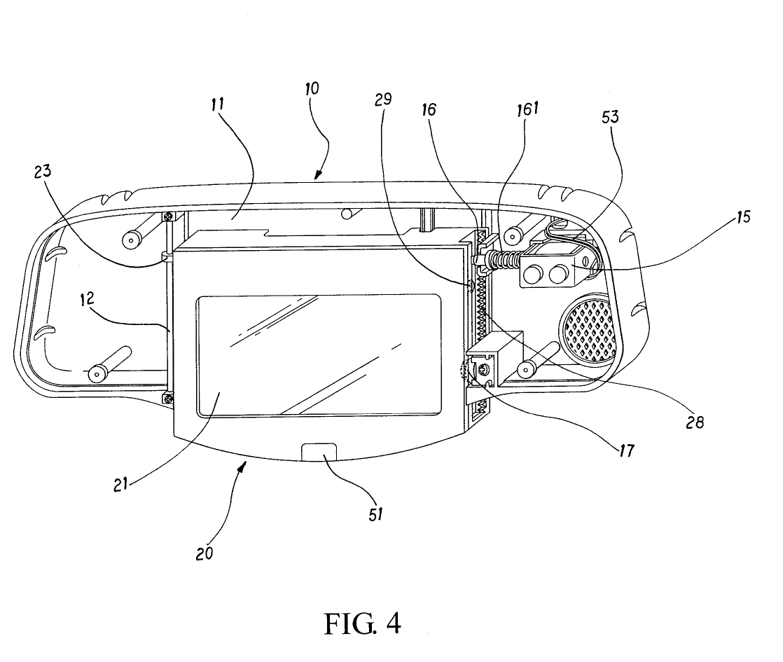

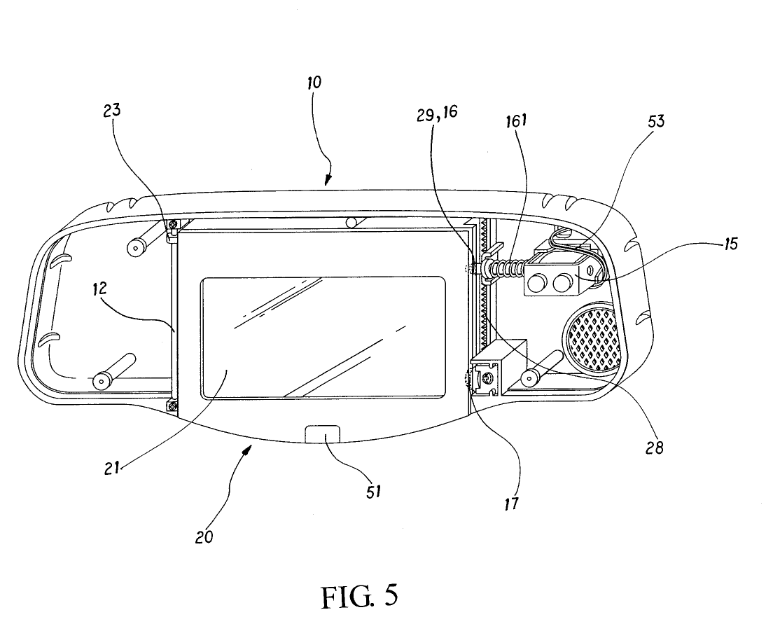

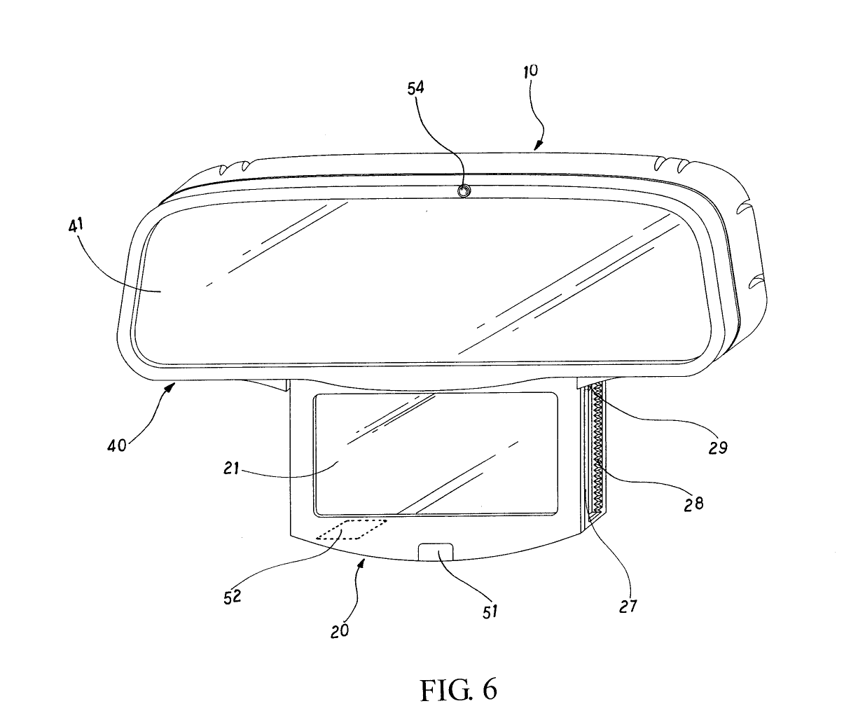

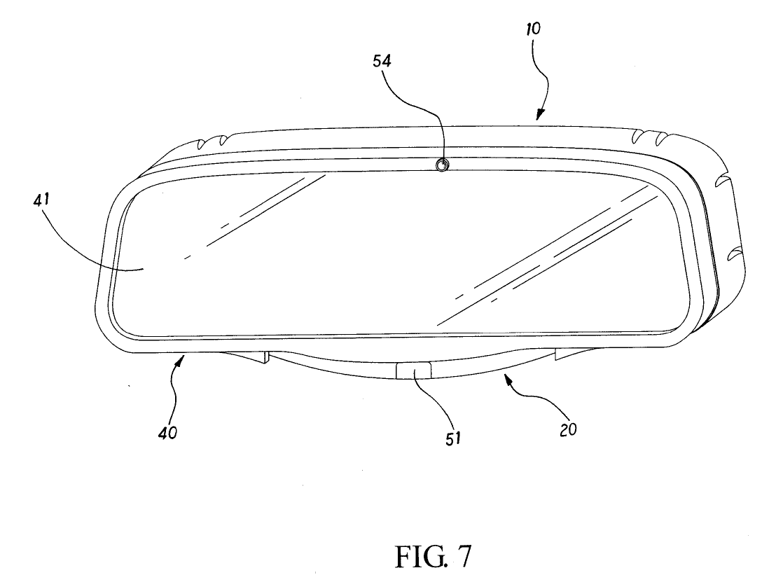

Referring to FIGS. 1, 5 and 7, the vehicle rear mirror having a display of the present invention can be installed to a rear mirror of a vehicle through the seat 10. Normally, when it is not used, the body 20 with the display unit 21 can be hidden between the mirror 40 and the seat 10 so that it has an appearance like the general used rear mirror. The use can directly see the mirror surface of the mirror 40 for viewing the image at the backside. When the user desires to see the display unit 21, the electromagnetic valve 15 is actuated by above mentioned three ways so that the insertion rod 16 reduces inwards transversally to separate from the insertion hole 29 of the body 20. Thus the body 20 is released so that the body 20 is acted by the resilient force of the compressible spring 30 to be pushed away and thus to protrude out of the lower side of the mirror 40, as illustrated in FIGS. 3, 4, and 6 so as to complete the retraction action of the display unit 21 and thus the user can view the images from the display unit 21. Similarly, when the user desires to store the body 20, it only needs to push the body 20 upwards so that the body 20 slides and positions. Then the insertion rod 16 in the seat 10 can be ejected out by the restorable spring 161 to transversally insert to the insertion hole 29 of the body 20 so as to lock the body 20 to the seat 10, as shown in FIG. 5. Both in protruding or storing operations, in the slide process, the slide guide device between the body 20 and the seat 10 serves to precisely control the slide operation. Furthermore, other engagement device can be provided for damping and thus makes the process more steady.

As comparing with the prior art, the present invention not only precisely provides the functions of limitation, steady sliding and buffering so as to avoid the effect of buckling and stopping, shocking, and vibration which will affect the image and viewing qualities and reduce the lifetime of the device. More important, the locking and releasing of the insertion rod from the insertion hole are controlled through an electromagnetic valve which is controlled wirelessly, wired and can be performed by touch control in far end. The operation is easy and conveniently with less force. Besides, the display unit 21 can be installed to the mirror 40 so as to provide rear time images to have the effects of image storage and burglar proof. Furthermore, it provides a further value to the device of the present invention.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A vehicle rear mirror having a display, comprising:
a seat having an insertion rod which is controlled by an electromagnetic valve;
a body having a display unit; the body being slideable along the seat; the body being capable of moving outwards by an elastic force; one side of the body corresponding to the insertion rod of the seat having an insertion hole; when the body is in front of the seat; the insertion hole can receive the insertion rod so as to fix the body; when the insertion rod is released from the insertion hole, the body can be pushed outwards by elastic force; and
a mirror with a mirror surface, the mirror being installed at a front side of the seat; when the body slides inwards, the body being hidden between the mirror and the seat; and when the body slides outwards, the body exposes out from an outer edge of the mirror.

2. The vehicle rear mirror having a display as claimed in claim 1, wherein a slide guide device is installed between a front wall of the seat and a rear wall of the body.

3. The vehicle rear mirror having a display as claimed in claim 2, wherein the slide guide device includes a guide rod and a track which are installed at two sides of the seat; and a sliding block and a track slot are installed at two sides of the body; the slide block has a through hole for receiving the guide rod so that the sliding block is movable along the guide rod; and the track of the seat is embedded into the track groove for guiding the seat.

4. The vehicle rear mirror having a display as claimed in claim 1, wherein an elastic device is installed between the seat and a rear wall of the body.

5. The vehicle rear mirror having a display as claimed in claim 4, wherein the elastic device includes at least one compressible spring, a top positioning portion at a front wall of the seat; and a lower positioning portion on the rear wall of the body; an upper and a lower end of the compressible spring resist against the top positioning portion and the lower positioning portion, respectively, so as to push the body downwards and outwards.

6. The vehicle rear mirror having a display as claimed in claim 5, wherein the top positioning portion of the seat is formed with a spring limiting groove.

7. The vehicle rear mirror having a display as claimed in claim 5, wherein the lower positioning portion of the body is formed with a spring limiting groove.

8. The vehicle rear mirror having a display as claimed in claim 1, wherein one lateral wall of the seat corresponding to the lateral wall of the body is provided with an engagement device for providing damping effect as the body slides.

9. The vehicle rear mirror having a display as claimed in claim 8, wherein the engagement device has an oil pressure gear installed at one side of the front wall of the seat and a rack which is engaged to the oil pressure gear.

10. The vehicle rear mirror having a display as claimed in claim 1, wherein the wireless receiver is controlled by a wireless remote controller.

11. The vehicle rear mirror having a display as claimed in claim 10, wherein the wireless remote controller is an infrared controller.

12. The vehicle rear mirror having a display as claimed in claim 10, wherein the wireless remote controller is used with a wireless receiver which is installed at a font lower side of the body.

13. The vehicle rear mirror having a display as claimed in claim 1, wherein the electromagnetic valve is a touch control switch.

14. The vehicle rear mirror having a display as claimed in claim 13, wherein the touch control switch is installed at a front lower side of the body.

15. The vehicle rear mirror having a display as claimed in claim 1, wherein the electromagnetic valve is controlled by a far end wired control.

16. The vehicle rear mirror having a display as claimed in claim 15, wherein the far end wire control includes a main frame having a touch control switch or with a wireless remote control function and a wire connected between the main frame and the electromagnetic valve so as to control the electromagnetic valve through the mainframe.

17. The vehicle rear mirror having a display as claimed in claim 1, wherein the mirror further includes a digital camera lens.

18. The vehicle rear mirror having a display as claimed in claim 17, wherein the digital camera lens is installed at a front upper side of the mirror.
